(19) United States
(12) Patent Application Publication
(10) Pub. No.: US 2008/0007585 A1
(43) Pub. Date: Jan. 10, 2008

(54) ON-PAPER PRELIMINARY EJECTION METHOD, PRINTER, AND PRINTER DRIVER

(75) Inventor: Kenji Ueda, Ibaraki (JP)

Correspondence Address: PATENTTM.US, P. O. BOX 82788, PORTLAND, OR, 97282-0788, US

(73) Assignee: CANON FINETECH INC., Ibaraki (JP)

(21) Appl. No.: 11/773,627

(22) Filed: Jul. 5, 2007

(30) Foreign Application Priority Data
Jul. 7, 2006 (JP) 2006-187417

(51) Int. Cl. B41J 2/205

(52) U.S. Cl. 347/15

(57) ABSTRACT

An information processing device that generates image data to be printed or a printer that receives this image data analyzes the image data to be printed to detect a low-lightness area as a preliminary ejection target area where the ink of a particular low-lightness color, included in the image to be printed, is recorded. Preliminarily-ejected ejection data of a high-lightness color ink is added to the image data so that on-paper preliminary ejection of higher-lightness color ink is performed in the low-lightness area as necessary. This preliminary ejection reduces the effect of the preliminary ejection on the image quality without interrupting the printing.

### DETAILED DESCRIPTION

1. Field of the Invention

The present invention relates to a printer that has recording heads for ejecting ink from the nozzles thereof, and more particularly to a printer that has a function that preliminarily ejects ink directly on a printing medium during a printing operation.

2. Related Art

On a printer such as an inkjet printer having recording heads for ejecting ink from the nozzles thereof, the viscosity of ink in the nozzles, from which ink is ejected less frequently, tends to increase depending upon the print image. This increased viscosity sometimes results in improper ink ejection and degraded print quality. To prevent this, the operation, called preliminary ejection in which ink is forced to be ejected, is performed for each nozzle to prevent non-ejection state from lasting for a predetermined time or longer.

Conventionally, this preliminary ejection is performed in a predetermined area other than a printing medium or on a printing medium itself (See Japanese Patent Laid-Open Publication No. Sho 55-139269). Preliminary ejection performed on a printing medium itself is called on-paper preliminary ejection.

On-paper preliminary ejection, in which ink is ejected preliminarily on a printing medium during the printing of an image, does not require the print operation to be interrupted for the purpose of preliminary ejection. Today, on-paper preliminary ejection becomes more useful, because recent advances in the micro fabrication technology for ink nozzles make the radius of a dot, formed by an ink droplet, still smaller and make isolated dots less conspicuous.

For use in an inkjet printer that uses on-paper preliminary ejection, a technique has been proposed for reducing unwanted preliminary ejection as much as possible (See Japanese Patent Laid-Open Publication No. 2006-076247).

Also, for use on an inkjet printer that uses on-paper preliminary ejection, another technique has been proposed for performing preliminary ejection in a pre-set area, such as the flap, bonding part, and overlap width of a cardboard or an envelop, at an ink density not higher than a predetermined density (Japanese Patent Laid-Open Publication No. 2006-103279).

However, the micro-fabricated nozzles increase the possibility of improper ink ejection, creating a need for more frequent preliminary ejection. In full-color printing, a plurality of recording heads are usually used to eject a plurality of colors such as cyan (C), magenta (M), yellow (Y), and black (K). In this printing situation, the recording heads of all colors preliminarily eject ink and, as a result, many preliminary ejection dots are formed on a printing medium.

The technique disclosed in Japanese Patent Laid-Open Publication No. 2006-076247 described above reduces unwanted preliminary ejection but performs preliminary ejection in a blank area other than an area where a print object is formed based on its image data. This could result in that the dots formed by preliminary ejection may degrade the image quality although not so conspicuous.

The technique disclosed in Japanese Patent Laid-Open Publication No. 2006-103279 keeps the preliminary ejection away from the area where an image is recorded to avoid degradation in image quality. However, the problem with this technique is that the printing medium available is limited to special printing media such as a cardboard and an envelope, etc.

In view of the foregoing, it is an object of the present invention to provide an on-paper preliminary ejection method, a printer, and a printer driver that reduce the effect of preliminary ejection on image quality without print interruptions caused by the preliminary ejection.

### SUMMARY OF THE INVENTION

According to the present invention, there is provided an on-paper preliminary ejection method for use in a printing device that has a plurality of recording heads from which ink of a plurality of colors is ejected on a printing medium through nozzles. The on-paper preliminary ejection method comprises the steps of analyzing image data to be printed for detecting a low-lightness area, where ink of a particular low-lightness color included in an image to be printed is recorded, as a preliminary ejection target area; and adding preliminarily-ejected ejection data of high-lightness color ink to the image data so that on-paper preliminary ejection of higher-lightness color ink is performed in the low-lightness area as necessary.

For example, the low-lightness color is a black color and the high-lightness color is a non-black color. Alternatively, the low-lightness color is a dark shade of a color and the high-lightness color is a light shade of the same color.

This on-paper preliminary ejection method analyzes image data to be printed for detecting a low-lightness area, where ink of a particular low-lightness color included in an image to be printed is recorded, as a preliminary ejection target area that will be used for the preliminary ejection; and performs the on-paper preliminary ejection of higher-lightness color ink in the low-lightness area as necessary. That is, this method performs the preliminary ejection on top of a pixel that originally exists in the image, avoids preliminary ejection in a blank area and, as a result, prevents degradation in image quality.

The step of adding preliminarily-ejected ejection data may comprise the step of checking whether or not an amount of ink discharged on a pixel in an area of the low-lightness color will become excessive if the high-lightness color ink is preliminarily ejected at a position of the pixel and, if so, suppressing the addition of the preliminarily-ejected ejection data, corresponding to the nozzle, to the position of the pixel. This prevents ink from being excessively discharged at the same pixel position.

In another aspect according to the present invention, there is provided an on-paper preliminary ejection method for use in a printing device that has recording heads from which ink is ejected on a printing medium through nozzles. This on-paper preliminary ejection method comprises the steps of detecting pixels that will become a preliminary ejection target area on the printing medium for at least a recording head of particular ink; setting the pixels that was detected, as the preliminary ejection target area; and adding preliminarily-ejected ejection data to image data so that preliminary ejection is performed for nozzles of the recording head of the particular ink in the preliminary ejection target area that was set wherein the nozzles are those for which the preliminary ejection is required.

This method sets the preliminary ejection target area, which is used for preliminary ejection on the printing medium, for at least a recording head of particular ink and preliminarily ejects ink in that area, thus avoiding preliminary ejection in other areas. In addition, even though preliminary ejection is performed in areas other than the preliminary ejection target area used for preliminary ejection, the ratio of those areas to the whole page is relatively low. As a result, even though on-paper preliminary ejection is performed, the print quality can be maintained.

Another on-paper preliminary ejection method according to the present invention is an on-paper preliminary ejection method for use in a printing device that has recording heads from which ink is ejected on a printing medium through nozzles. This method comprises the steps of, for at least a recording head of particular ink, adding a graphic to an image, which will be printed, for use as an area which will be set as a preliminary ejection target area on the printing medium, wherein the graphic has some predetermined shape in low-lightness color ink; and adding preliminarily-ejected ejection data to image data so that preliminary ejection is performed for nozzles of the recording head of the particular ink in the preliminary ejection target area that was set wherein the nozzles are those for which the preliminary ejection is required. In this case, the printing medium is a printing medium on which labels are pasted at an interval on a rolled base sheet and the graphic of some special shape is printed at spaces between the labels on the base sheet. This method allows the preliminary ejection to be performed without affecting the labels.

According to the present invention, there is provided a printing device that ejects ink from nozzles onto a printing medium to print an image. This printing device comprises a plurality of recording heads from which ink of a plurality of colors is ejected; a data analyzer that analyzes received image data for detecting an area of a particular low-lightness color, which is included in an image to be printed, as a preliminary ejection target area that will be used for preliminary ejection; and a data processor that adds preliminarily-ejected ejection data of a high-lightness color to the image data so that on-paper preliminary ejection of high-lightness color ink is performed in the low-lightness color area as necessary.

According to the present invention, there is provided another printing device that ejects ink from nozzles onto a printing medium to print an image. This printing device comprises a plurality of recording heads from which ink of a plurality of colors is ejected; a data receiver that receives image data to be printed, as well as preliminary ejection target area data that specifies an area of a particular color, which is included in an image to be printed, as a preliminary ejection target area that is used for preliminary ejection; and a data processor that adds preliminarily-ejected ejection data of another color ink to image data so that on-paper preliminary ejection of the another color is performed as necessary in the area which has the particular color.

The present invention can also be taken as a printer driver that generates image data for use in a printing device that has recording heads from which ink is ejected on a printing medium through nozzles.

The present invention allows preliminary ejection to be performed directly on a printing medium to avoid print interruptions caused by the preliminary ejection and, therefore, prevents degradation in throughput. At the same time, the present invention performs preliminary ejection in a low-lightness area in which a particular low-lightness ink included in an image to be printed is recorded, or performs preliminary ejection in a predetermined preliminary ejection target area, to reduce an effect on the image quality.

### BRIEF DESCRIPTION OF THE DRAWINGS

FIG. 1 is a diagram showing the general configuration of a print system in a first embodiment of the present invention;

FIG. 2 is a diagram showing the general configuration of one recording unit mounted on a printer in this embodiment;

FIG. 3 is a flowchart showing the general processing performed in an information processing device in FIG. 1 for image data of a print object before a print instruction is issued to the printer;

FIG. 4 is a diagram showing an example of a configuration for determining “Is preliminary ejection required for target nozzle?” in step S13 in FIG. 3;

FIG. 5 is a diagram showing a modification of the configuration shown in FIG. 4;

FIG. 6 is a flowchart showing a modification of the processing in FIG. 3;

FIG. 7 is a diagram showing an example of the general configuration of a print system in a second embodiment of the present invention;

FIG. 8 is a flowchart showing an example of specific processing for generating preliminary ejection target area data performed by an information processing device in this embodiment of the present invention;

FIG. 9 is a flowchart showing an example of processing that is performed in this embodiment of the present invention when a printer receives print image data in the RGB format, as well as preliminary ejection target area data, from the information processing device.

FIG. 10 is a flowchart showing a modification of the processing in FIG. 9;

FIG. 11 is a diagram showing an example of a form used, for example, in the field of physical distribution to which the print system in the embodiment of the present invention is advantageously applied; and

FIG. 12 is a diagram showing still another embodiment of the present invention.

### DETAILED DESCRIPTION OF THE PREFERRED EMBODIMENTS

Preferred embodiments of the present invention will be described in detail below with reference to the drawings.

### First Embodiment

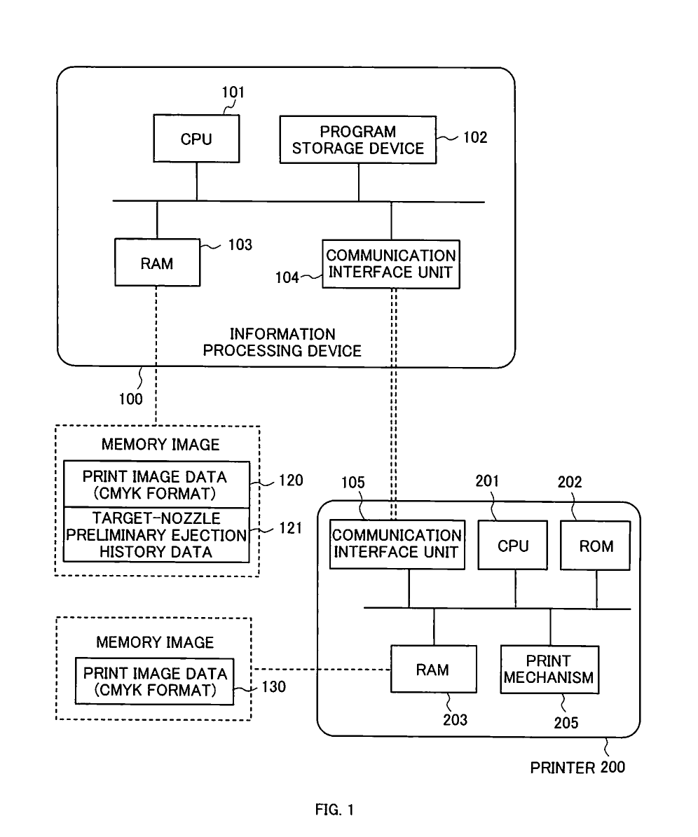

FIG. 1 is a diagram showing the general configuration of a print system in a first embodiment of the present invention.

This print system comprises an information processing device 100 that is a transfer source device from which print object data is transferred and a printer 200 that is an example of a print device. The information processing device 100 and the printer 200 are interconnected via a communication interface.

The information processing device 100 comprises a CPU 101, a program storage device 102, a RAM 103, and a communication interface (communication IF) unit 104.

The CPU 101 is a central processing unit that executes various programs to control the components of the information processing device 100. The program storage device 102 is a storage device in which programs such as the operating system (OS), device drivers, and application software are stored. The program storage device 102 is, for example, a large-capacity nonvolatile storage device such as a hard disk drive or the like. The processing of the flowcharts, which will be described below, is implemented by at least one of those programs.

The RAM 103, a memory configuring the work area and the temporary storage area for the CPU 101, stores data related to printing in this embodiment such as print image data (in CMYK format) 120 and target-nozzle preliminary ejection history data 121 that will be described below. The communication interface (IF) unit 104, for example a USB interface, is an interface for communicating data to and from a device with which data is communicated. Note that the communication interface is not limited to the USB. For example, the serial interface such as RC-232C, IrDA, and IEEE 1394, the parallel interface such as IEEE1284, SCSI, and IDE, and/or a network interface may also be used.

The printer 200 is an inkjet printer having a CPU 201, a ROM 202, a RAM 203, and an inkjet recording print mechanism 205.

The CPU 201 is a central processing device that executes various programs to control the components of the printer 200.

The ROM 202 is a nonvolatile memory in which the control programs of the printer 200 are stored. The ROM 202 may include a rewritable nonvolatile memory in which data such as various parameters is stored.

The RAM 203 is a memory that configures the work area and the temporary storage area of the CPU 201 for storing print-related data in this embodiment such as print image data (in CMYK format) 130.

A communication IF unit 105 is a communication IF unit corresponding to the communication IF unit 104 of the information processing device 100.

The print mechanism 205 is a print mechanism that prints data based on the print image data 130 transferred from the information processing device 100. In this embodiment, the print mechanism using the inkjet recording method is used. The recording heads are the so-called line-type recording heads (line heads) whose nozzle columns extend across the full paper width. The present invention, though not limited to the line-head type recording heads, is most suitable for line heads.

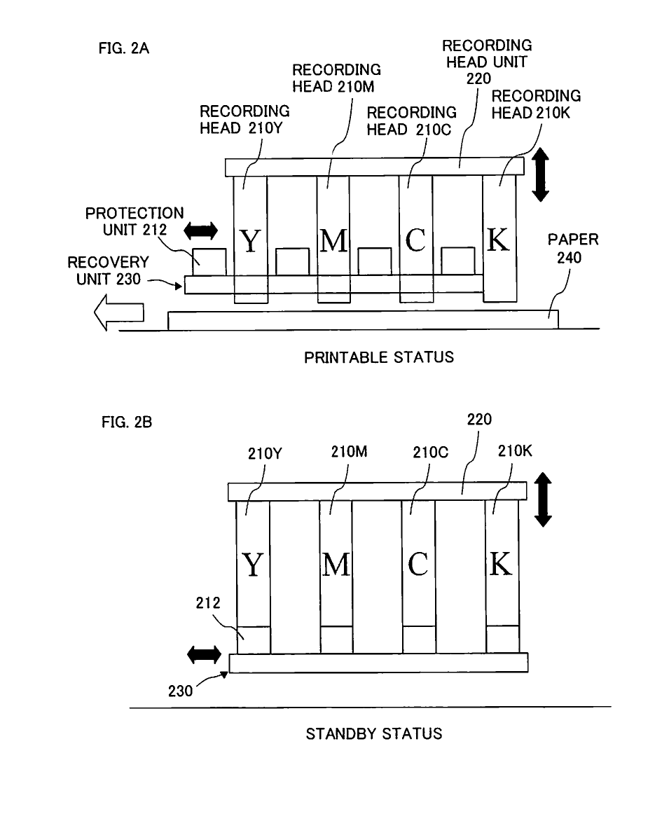

FIG. 2 is a diagram showing the general configuration of one recording unit mounted on the printer in this embodiment. This recording unit is composed of four recording heads 210K-210Y, which are line heads, and a recovery unit 230 that cleans the recording heads. The four recording heads 210K-210Y, combined into one as a recording head unit 220, is moved vertically by a head unit control motor (not shown). The recovery unit 230 has recording head protection units 212, one for each recording head 210, and is moved in the horizontal direction by a recovery unit control motor (not shown). The “horizontal direction” as mentioned herein refers to the direction parallel to the conveyance direction of paper 240.

The recording head unit 220 and the recovery unit 230 are moved to a predetermined position where an image is printed at a printing time as shown in FIG. 2A, and to a predetermined standby position at a non-printing time as shown in FIG. 2B.

The following describes the operation of this system.

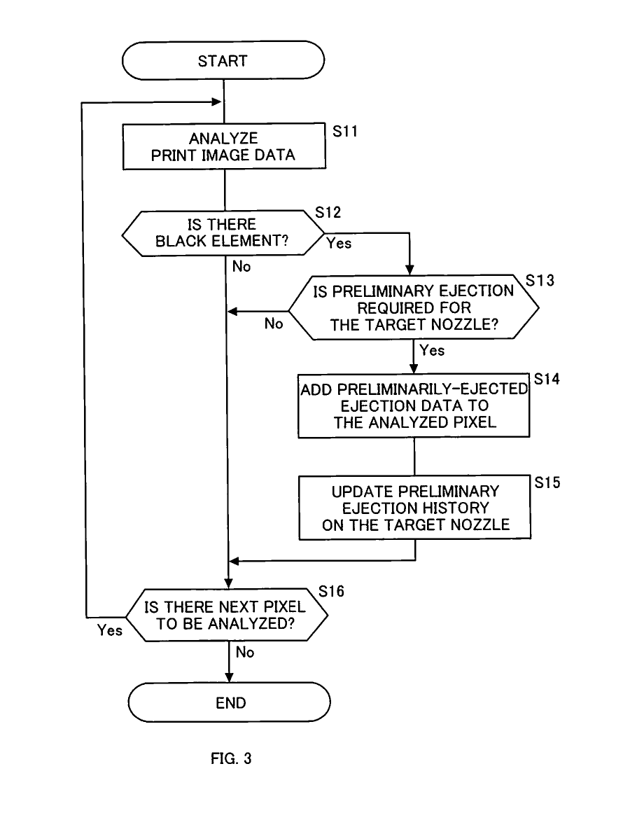

FIG. 3 is a flowchart showing the general processing performed in the information processing device 100 in FIG. 1 for print object image data (print image data) before a print instruction is issued to the printer 200.

This processing is performed by the CPU 101 that reads a computer program, such as the printer driver, from the program storage device 102 and executes it. In this example, print image data, CMYK-format data corresponding to ink colors used by the printer, is generated by the information processing device 100. The CPU 101 of the information processing device 100 is “data processor” of the present invention.

The operation performed by the processing in FIG. 3 is as follows. That is, the information processing device 100 finds a pixel at which black ink is ejected and, for the non-black color nozzles (target nozzles) from which ink can be ejected at that pixel position, changes print image data so that preliminary ejection is performed if necessary. This preliminary ejection operation ejects non-black color ink droplets on top of the black ink droplet without forming a preliminarily ejected dot separately with the image, with a slight change, if any, in the image color, thus avoiding degradation in print quality.

Referring to FIG. 3, the information processing device 100 first analyzes print image data, one pixel at a time, in step S11. Next, the information processing device 100 checks in step S12 whether a black (K) element is included in the analyzed pixel.

If a black element is detected, the information processing device 100 checks in step S13 whether preliminary ejection is required for the target nozzles corresponding to the analyzed pixel. Note that “preliminary election required” means that preliminary ejection is required for preliminary ejection candidate nozzles because a predetermined time has elapsed since the previous ejection of ink. In an example in which line-type recording heads are used, the elapse of a “predetermined time” means that the number of consecutive non-ejected lines (rasters) after the previous ejection of ink from the target nozzle exceeds a predetermined threshold Th. The threshold Th can be determined by a time calculated by subtracting a predetermined margin time from the permissible maximum non-ejection time, the paper conveyance speed, and the resolution (m lines/inch, etc.) in the paper conveyance direction.

The “previous ejection” could be either an ejection based on preliminarily-ejected ejection data or an ejection based on specific image data. If it is determined that preliminary ejection is required, the information processing device 100 adds preliminarily-ejected ejection data, corresponding to each nozzle, in the analyzed pixel position in step S14 and updates the preliminary ejection history data on the nozzle in step S15. A specific example of this updating will be described below.

If it is found in step S12 that no black element is included in the pixel, or if it is found in step S13 that preliminary ejection is not required for the target nozzle, or after step S15 is performed, the information processing device 100 checks in step S16 if there is a next pixel to be analyzed. If there is a next pixel to be analyzed, control is passed back to step S11 to analyze the image data.

The print image data, to which preliminarily-ejected ejection data is added in this way, is converted to printer commands and is sent to the printer.

Not only the print image data (converted to CMYK format) 120 and the target-nozzle preliminary ejection history data 121 but also a part of them or other data can also be saved in the RAM 103.

The storage device is not limited to the RAM 103. For example, a magnetic storage medium (flexible disk, hard disk, magnetic tape, etc.), an optical disc (optical magnetic disc such as MO and PD, CD-ROM, CD-R, CD-RW, DVD-ROM, DVD-RAM, DVD-R, DVD-RW, DVD+RW, etc), and a rewritable nonvolatile semiconductor memory can also be used as the storage device.

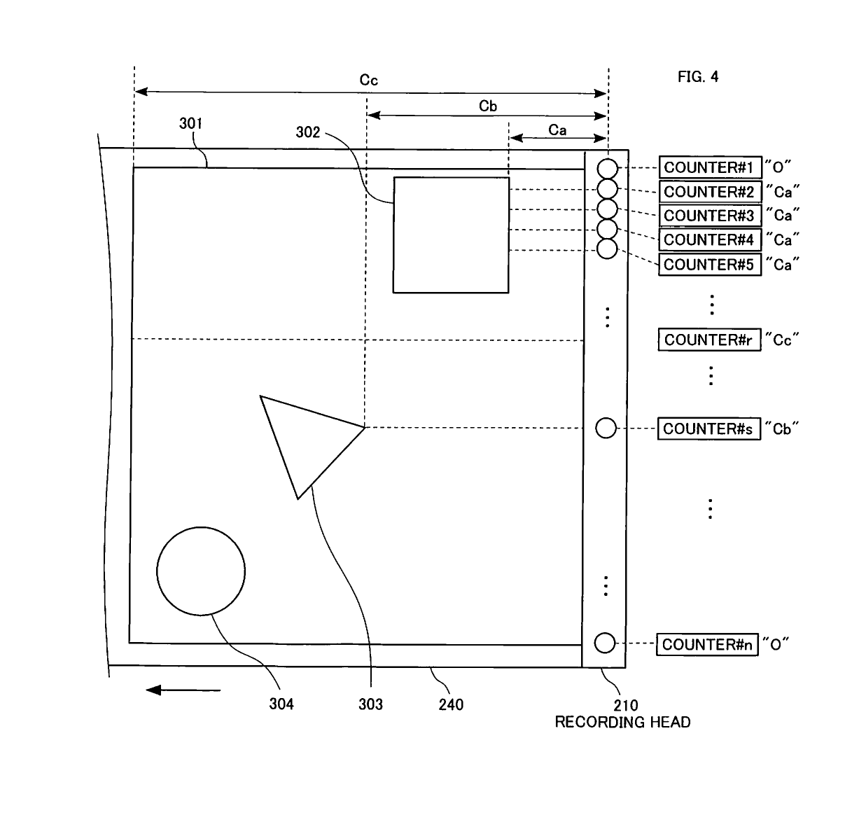

Referring to FIG. 4, the following describes how the condition “Is preliminary ejection required for target nozzle?” in step S13 is processed. The line-type recording head 210 is described here. For each recording head 210 that ejects non-black ink (yellow, magenta, and cyan in this example), counters 50 are provided, one for each nozzle. During image analysis, each counter 50 is reset to 0 at a point when ink is ejected from the corresponding nozzle, and is incremented by 1 for each line of the image data until image data (pixel data) that requests the ejection of ink from the nozzle appears. Therefore, the values of the counters 50 in FIG. 4 configure the target-nozzle preliminary ejection history data 121 shown in FIG. 1.

When a closing line 301 and graphics 302-304, which are images in the figure, include black elements, the pixel positions corresponding to those black elements become candidates for positions in which preliminary ejection of other colors is performed. Whether or not preliminary ejection is actually performed in the candidate positions is determined based on the target-nozzle preliminary ejection history data 121 that is sequentially updated. That is, whether or not preliminary ejection is required is determined based on whether or not the time elapsed from the moment ink was ejected last from the nozzle exceeds a predetermined time, that is, whether or not the number of consecutive non-ejection lines (rasters) after the previous ejection exceeds a predetermined threshold Th. Each counter is reset at point when ink is ejected from the nozzle and is incremented to count lines while lines, on which ink is not ejected, appear consecutively. The resetting and incrementing operation of this counter correspond to the updating of the target-nozzle preliminary ejection history data 121. After that, if the counter value is larger than Th when the nozzle reaches a preliminary ejection candidate position, the information processing device 100 adds the preliminarily-ejected ejection data to the image data so that the preliminary ejection of the nozzle is performed at that pixel position.

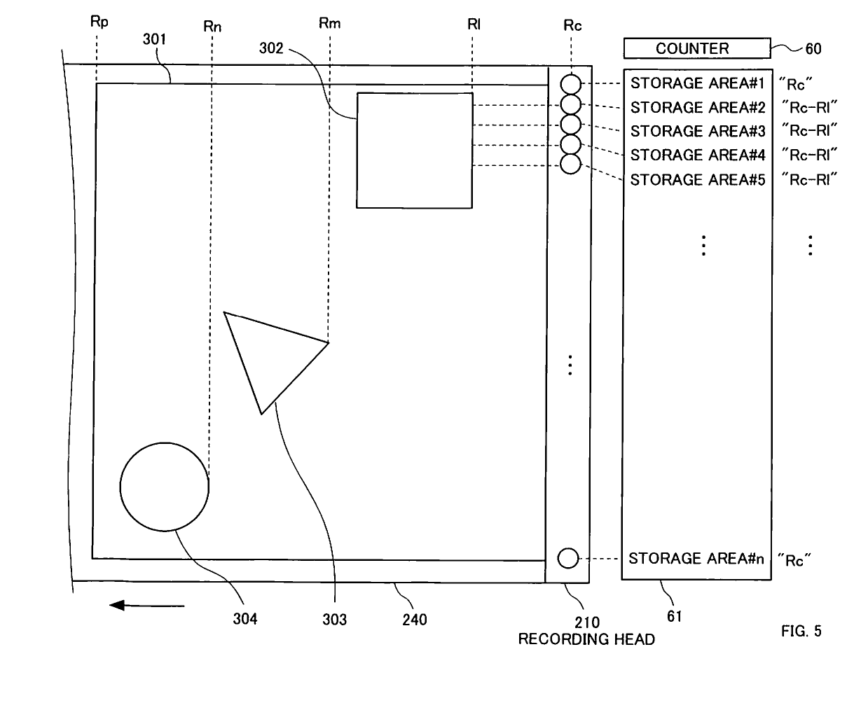

FIG. 5 is a diagram showing a modification of the configuration shown in FIG. 4. The counters are provided, one for each nozzle of the recording heads for non-black colors in the configuration shown in FIG. 4. In contrast, in this example, only one counter is provided for common use by the recording heads and the nozzles of thereof, and storage areas 61 are provided, one for each nozzle of each recording head. When image data is analyzed, a counter 60 starts at the initial value of 0 and is incremented line by line. The count value when ink was ejected last (stored in the storage area 61) is subtracted from the current count value (stored in the counter 60) to find the number of consecutive, non-ejection lines similar to that calculated in FIG. 4. Therefore, in FIG. 5, the values in the storage areas 61 configure the target-nozzle preliminary ejection history data 121 shown in FIG. 1.

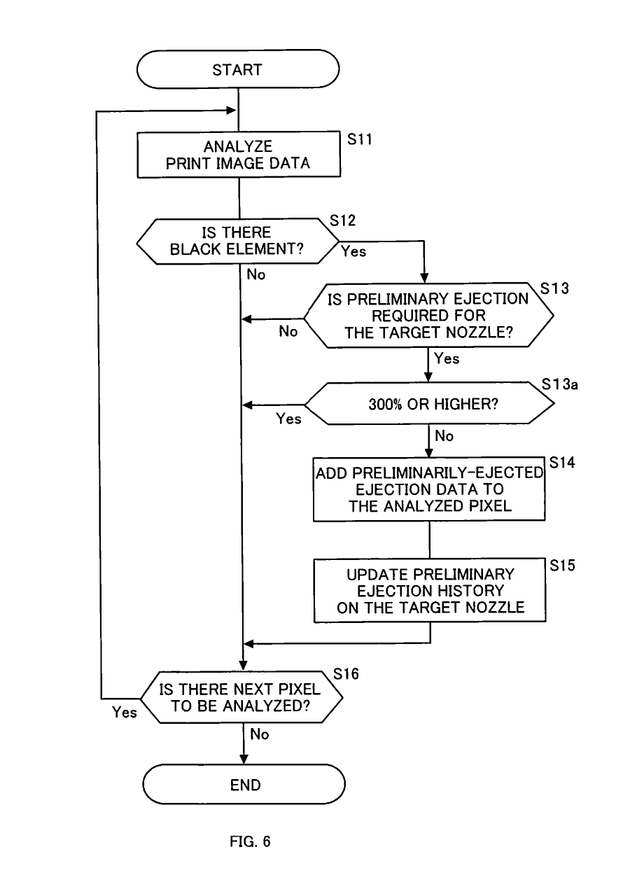

FIG. 6 is a flowchart showing a modification of the processing shown in FIG. 3. In FIG. 6, the same reference numerals are used to denote the same steps as those in FIG. 3, and the duplicated description will be omitted. The processing in FIG. 6 is similar to that in FIG. 3 except that the decision step in step S13a is added after step S13. When a plurality of ink droplets are ejected (discharged) at the same pixel position and, as a result, the duplicated discharge rate becomes too high, a blur or stain appears locally in the corresponding position on the paper 240 used as the printing medium. The “duplicated discharge rate” as mentioned herein corresponds to the density of ink ejected in the same dot position, and when the ink droplet ejection from one is 100%, the ink droplet ejection from n nozzles becomes n×100%. In this embodiment, the duplicated discharge rate is 400% when ink of all four colors is ejected at the same pixel position.

To avoid this problem, even though it is determined in step S13 that “preliminary ejection is required” for a target nozzle, the information processing device 100 checks in step S13a of the processing flow in FIG. 6 whether the duplicated discharge rate becomes equal to or higher than a predetermined value (for example, 200% or 300%) if preliminary ejection is added to that target pixel. If the duplicated discharge rate becomes equal to or higher than the predetermined value, control is passed not to step S14 but to step S16. Passing control directly to step S16 in this way prevents preliminary ejection from being performed at that pixel position.

An appropriate predetermined value for the duplicated discharge rate may be fixed or may be variably set according to the type of paper (type or thickness of printing medium) because the print result depends on the paper type.

The processing described above suppresses the preliminary ejection for a nozzle that is determined as “preliminary ejection required”. Because the width of a ruled line or a line forming a character is of usually a plurality of pixels, a pixel position that includes a black pixel is usually followed by the next line that also includes a black pixel. Therefore, preliminary ejection can be performed separately for a plurality of non-black ink colors around the same pixel position.

### Second Embodiment

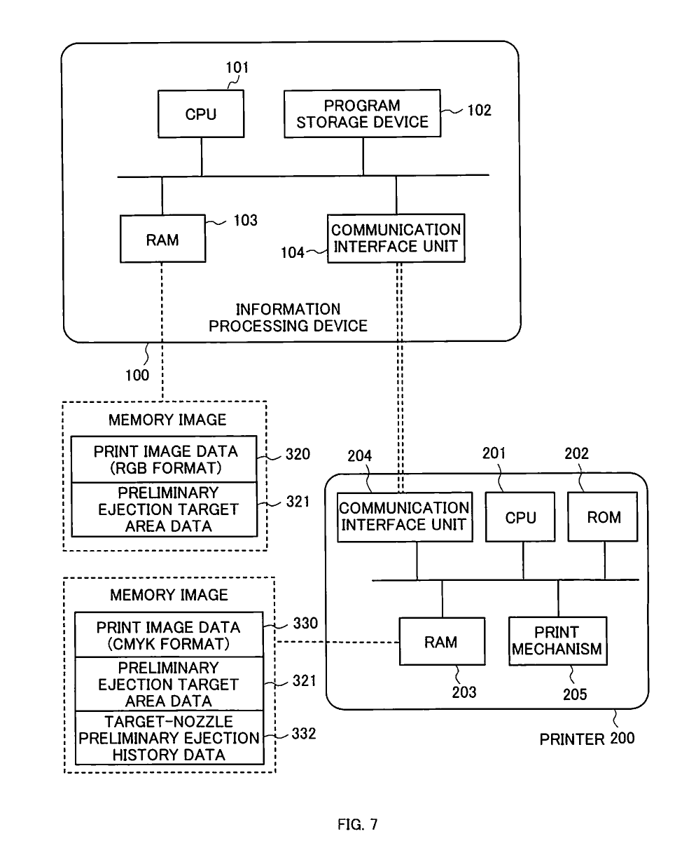

FIG. 7 is a diagram showing an example of the general configuration of a print system in a second embodiment of the present invention. In this figure, the same reference numerals are used to denote the same elements shown in FIG. 1, and further description of those elements will be omitted.

The configuration shown in FIG. 7 differs from the configuration in FIG. 1 in the following points. That is, the first point is that print image data 320 stored in a RAM 103 in an information processing device 100 is in the RGB format and, based on this data, preliminary ejection target area data 321 is generated and that the print image data 320 and the preliminary ejection target area data 321 in the RGB format are sent to a printer 200. The second point is that print image data 330 in the CMYK format is generated in the printer 200. During this generation, the preliminary ejection target area data 321 is referenced, and preliminarily-ejected ejection data is added while updating target-nozzle preliminary ejection history data 332.

Although the “area” of the preliminary ejection target area generally refers to a two-dimensional range, the preliminary ejection target area as mentioned herein refers typically to an area defined by a set of particular pixels. For example, when a line recorded in particular-color ink is a preliminary ejection target area, the range of the pixels configuring the line could be the preliminary ejection target area. Even when a closed space graphic (for example, a rectangle) is formed by a line, the preliminary ejection target area is the pixels on that line and, basically, the inside enclosed by the line is not included. However, if the closed space is painted in the same color as that of the edge, the inside of the closed space could be of course the preliminary ejection target area.

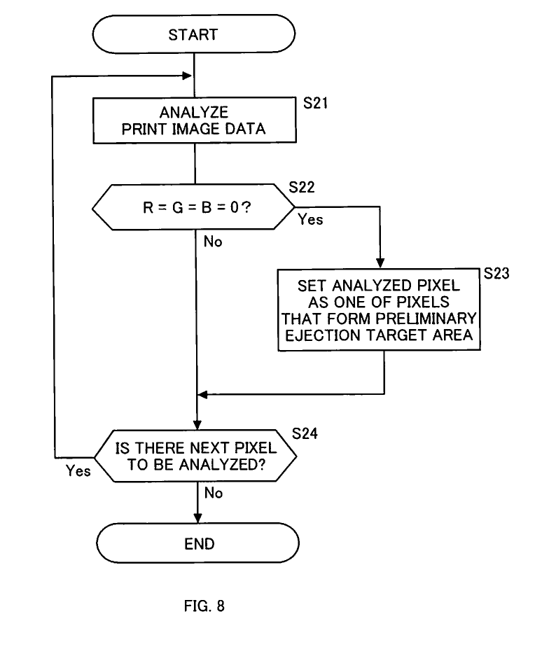

FIG. 8 is a flowchart showing an example of specific processing performed in the information processing device 100 for generating preliminary ejection target area data 321.

First, the information processing device 100 analyzes one pixel of print image data in step S21. First, the first pixel of the first line is analyzed. If this pixel data is R=G=B=0, that is, black, the information processing device 100 updates the preliminary ejection target area data 321 so that the analyzed pixel is set as one of pixels that form the preliminary ejection target area (S23).

If the pixel is not a black pixel in step S22, the information processing device 100 checks if there is a next pixel to be analyzed (S24). The pixel to be analyzed next is the next pixel on the same line as that processed in step S21 or, if there is no pixel on that line, the first pixel on the next line.

If there is a pixel to be analyzed next, control is passed back to step S21 to repeat the processing described above. This repeated processing generates the preliminary ejection target area data 321 that indicates the positions in a print image on one page for which preliminary ejection can be performed. This data, as well as the print image data in the RGB format, is sent to the printer 200.

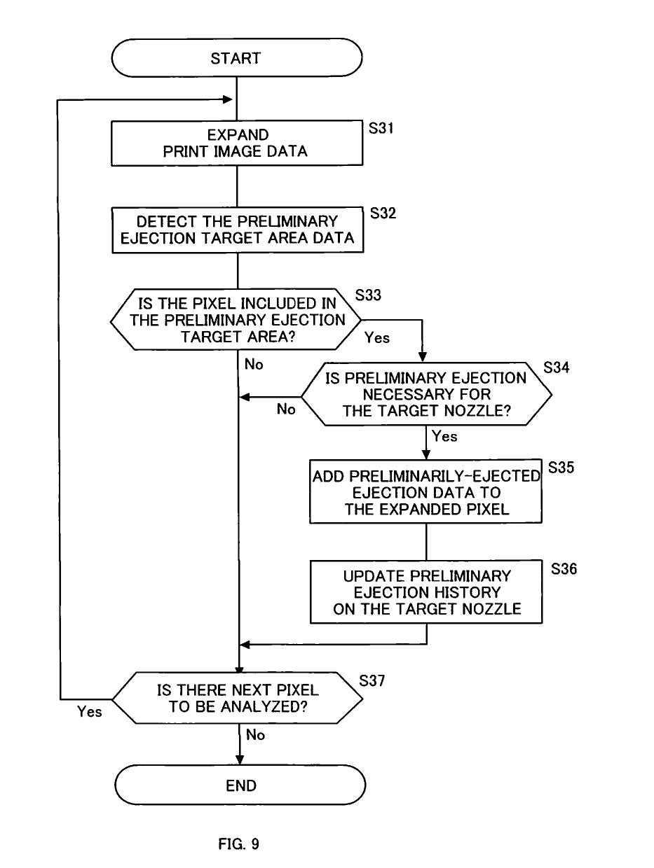

FIG. 9 is a flowchart showing an example of processing that is performed when the printer 200 receives the print image data 320 in the RGB format, as well as the preliminary ejection target area data 321, from the information processing device 100. This processing is performed by a CPU 201 in the printer 200 that reads the program from a ROM 202.

First, in step S31, the printer 200 converts the received print image data in the RGB format to print image data in the CMYK format and expands the data in the RAM 203 on a pixel basis. In step S32 that follows, the printer 200 detects the preliminary ejection target area data that was received with the print image data. In step S33, the printer 200 checks if the pixel is included in a preliminary ejection target area and, if not, checks in step S37 if there is a next pixel to be analyzed. If there is a next pixel to be analyzed, control is passed back to step S31 to repeat the processing described above.

If the checking in step S33 indicates that the pixel is included in a preliminary ejection target area, the printer 200 checks in step S34 whether preliminary ejection is necessary for the target nozzle and, if not, passes control to step S37. If preliminary ejection is necessary, the preliminarily-ejected ejection data is added to the expanded pixel in step S35. Next, in step S36, the printer 200 updates the preliminary ejection history of this target nozzle and, after that, passes control to step S37.

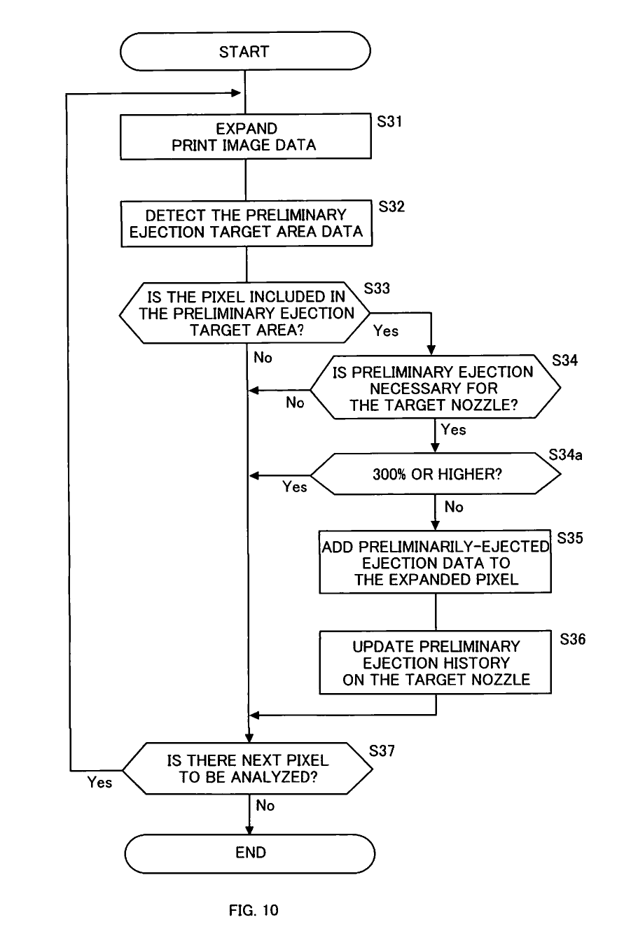

FIG. 10 is a flowchart showing a modification of the processing shown in FIG. 9. In FIG. 10, the same reference numerals are used to denote the same steps as those in FIG. 9, and the duplicated description will be omitted. The relation between FIG. 10 and FIG. 9 is the same as that between FIG. 6 and FIG. 3. That is, the processing in FIG. 10 is similar to that in FIG. 9 except that the decision step in step S34a is added after step S34. The effect of the operation is also the same as that of the operation in FIG. 6.

### Other Embodiments

Although preliminary ejection for black ink is not described in the embodiments described above, it is also possible to use the conventional on-paper preliminary ejection method at the same time for the black. In the conventional on-paper preliminary ejection method, preliminary ejection is performed on paper before a permissible maximum non-ejection time elapses regardless of whether or not the area is a preliminary ejection target area. Because a preliminary ejection target area is defined for non-black colors based on an image, the permissible maximum non-ejection time is sometimes exceeded. Considering this situation, it is also possible to use the conventional on-paper preliminary ejection method at the same time.

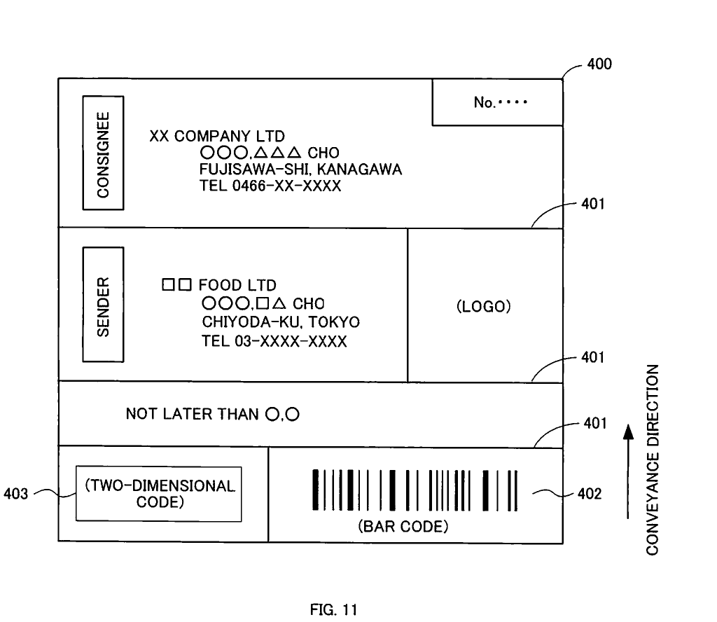

However, depending upon the use of a printer, there is no need to use the conventional on-paper preliminary ejection method at the same time. For example, a printer designed for printing various labels and forms prints an image including black ruled lines in many cases. FIG. 11 shows an example of a form 400 used, for example, in the physical distribution industry. As shown in this example, black horizontal ruled lines 401, orthogonal to the conveyance direction, are dispersed across the form and, by utilizing the pixel positions of the ruled lines, non-black color ink can be preliminarily ejected. In addition, because the interval between the horizontal ruled lines usually satisfies the maximum non-ejection time requirements, the conventional preliminary ejection need not be performed additionally. Nor is preliminary ejection necessary for the black color because ink is ejected from the nozzle to form horizontal ruled lines 401. A one-dimensional or two-dimensional bar code, such as areas 402 and 403, is recorded on this type of form in many cases. Dots, if recorded in this area during on-paper preliminary ejection, may lead to an improper operation when the bar code is read by a reader. This embodiment prevents preliminary ejection from being performed in this area.

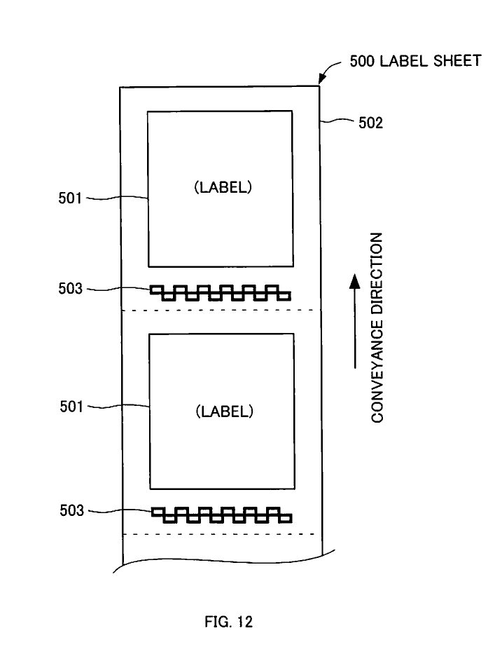

In addition, it is also possible for the information processing device 100 to add a graphic (or pattern) of some special shape to print image data to enable the printer to detect the position of the graphic of that some special shape from the received print image data and to recognize the graphic as the preliminary ejection target area. A preliminary ejection target area may have not only a special shape but also a limited size. To detect the graphic, an existing image processing technique may be used for the expanded image data. FIG. 12 is a diagram showing an example of a label sheet 500 suitable for forming such a preliminary ejection target area. When a predetermined image is printed in labels 501, which are equally spaced on a rolled base sheet 502 of the label sheet 500 and which have the same size and the same shape, black images 503 having a predetermined shape and extending across the print width on the paper are also printed as the graphics of some special form. This print layout allows the printer to recognize the graphic of this black image 503 as the preliminary ejection target area and to preliminarily eject only non-black ink in this area. If the length of label 501 is relatively short, the preliminary ejection time does not exceed the maximum permissible non-ejection time even though preliminary ejection is performed once in the label appearance period. The inside of a closed-space graphic formed by lines, though not included in the preliminary ejection target area as described above, may be included in the preliminary ejection target area in this case. This processing may be combined with the processing described above in which the black pixel positions are used as the preliminary ejection target area.

In the above description, print image data is analyzed to determine a preliminary ejection target area for each image. Instead, the information processing device 100 or the printer 200 may set in advance a preliminary ejection target area so that a predetermined area or an area except a special area is used as a preliminary ejection target area. Doing so prevents preliminary ejection from being performed in an area, such as the area 402 or 403 described above, where preliminary ejection is not desired.

Although non-black color ink is preliminarily ejected at a black pixel position in the examples described above, the present invention is not limited to the relation between black ink and non-black ink as long as the color does not change much when particular color ink is overlaid by some other color ink. For example, the two colors that differ in color thickness (lightness) may be used in the preliminary ejection, that is, light color ink may be preliminarily ejected in a dark color pixel position, for example, light cyan ink at a dark cyan pixel position or light magenta ink at a dark magenta pixel position.

While the preferred embodiments of the present invention have been described, it is to be understood that various changes and modifications may be made. For example, though a printer is used in the examples as a printing device, the printing device according to the present invention includes a facsimile machine and a copier.

Although only the line-type recording head is described above, the present invention may be applied also to a recording head that scans back and forth orthogonally to the paper conveyance direction. The present invention is not limited to a printer having four recording heads.

In the embodiment shown in FIG. 1, the CMYK print image data may be analyzed, and the preliminarily-ejected ejection data may be added, by the printer.

Computer programs that perform the functions satisfying the requirements described in the claims are included in the present invention. The programs may be object code programs that can be directly interpreted and executed by the processor, programs that are executed by the interpreter, or script data format programs that run under the OS or applications.

The storage medium for supplying computer programs is, for example, a magnetic storage medium (flexible disk, hard disk, magnetic tape, etc.), an optical disc (optical magnetic disc such as MO and PD, CD-ROM, CD-R, CD-RW, DVD-ROM, DVD-RAM, DVD-R, DVD-RW, DVD+RW, etc), semiconductor storage, paper tape, or a ROM device.

The image data may be of a bit-mapped graphic or a vector graphic.

1. An on-paper preliminary ejection method for use in a printing device that has a plurality of recording heads from which ink of a plurality of colors is ejected on a printing medium through nozzles, said on-paper preliminary ejection method comprising the steps of:
analyzing image data to be printed for detecting a low-lightness area, where ink of a particular low-lightness color included in an image to be printed is recorded, as a preliminary ejection target area that will be used for the preliminary ejection; and
adding preliminarily-ejected ejection data of high-lightness color ink to the image data so that on-paper preliminary ejection of higher-lightness color ink is performed in the low-lightness area as necessary.

2. The on-paper preliminary ejection method according to claim 1 wherein the low-lightness color is a black color and the high-lightness color is a non-black color.

3. The on-paper preliminary ejection method according to claim 1 wherein the low-lightness color is a dark shade of a color and the high-lightness color is a light shade of the same color.

4. The on-paper preliminary ejection method according to claim 1 wherein, if it is determined that a predetermined time has elapsed after ink was ejected last from a nozzle corresponding to each pixel in the preliminary ejection target area, it is determined that preliminary ejection is required for the nozzle.

5. The on-paper preliminary ejection method according to claim 1 wherein said step of adding preliminarily-ejected ejection data comprises the step of checking whether or not an amount of ink discharged on a pixel in an area of the low-lightness color will become excessive if the high-lightness color ink is preliminarily ejected at a position of the pixel and, if so, suppressing the addition of the preliminarily-ejected ejection data, corresponding to the nozzle, to the position of the pixel.

6. An on-paper preliminary ejection method for use in a printing device that has recording heads from which ink is ejected on a printing medium through nozzles, said on-paper preliminary ejection method comprising the steps of:
detecting pixels that will become a preliminary ejection target area on the printing medium for at least a recording head of particular ink;
setting the pixels that were detected, as the preliminary ejection target area; and
adding preliminarily-ejected ejection data to image data so that preliminary ejection is performed for nozzles of the recording head of the particular ink in the preliminary ejection target area that was set, said nozzles requiring the preliminary ejection.

7. An on-paper preliminary ejection method for use in a printing device that has recording heads from which ink is ejected on a printing medium through nozzles, said on-paper preliminary ejection method comprising the steps of:
for at least a recording head of particular ink, adding a graphic to an image, which will be printed, for use as an area which will be set as a preliminary ejection target area on the printing medium, said graphic having some predetermined shape in low-lightness color ink; and
adding preliminarily-ejected ejection data to image data so that preliminary ejection is performed for nozzles of the recording head of the particular ink in the preliminary ejection target area that was set, said nozzles requiring the preliminary ejection.

8. The on-paper preliminary ejection method according to claim 7 wherein said printing medium is a printing medium on which labels are pasted at an interval on a rolled base sheet and said graphic of some special shape is printed between the labels on the base sheet.

9. A printing device that ejects ink from nozzles onto a printing medium to print an image, comprising:
a plurality of recording heads from which ink of a plurality of colors is ejected;
a data analyzer that analyzes received image data for detecting an area of a particular low-lightness color, which is included in an image to be printed, as a preliminary ejection target area that will be used for preliminary ejection; and
a data processor that adds preliminarily-ejected ejection data of a high-lightness color to the image data so that on-paper preliminary ejection of high-lightness color ink is performed in the low-lightness color area as necessary.

10. The printing device according to claim 9 wherein the low-lightness color is a black color and the high-lightness color is a non-black color.

11. The printing device according to claim 9 wherein the low-lightness color is a dark shade of a color and the high-lightness color is a light shade of the same color.

12. The printing device according to claim 9 wherein
said data processor checks whether or not an amount of ink discharged on a pixel in an area of the low-lightness color will become excessive if the high-lightness color ink is preliminarily ejected at a position of the pixel and, if so, suppresses the addition of the preliminarily-ejected ejection data, corresponding to the nozzle, to the position of the pixel.

13. A printing device that ejects ink from nozzles onto a printing medium to print an image, comprising:
a plurality of recording heads from which ink of a plurality of colors is ejected;
a data receiver that receives image data to be printed, as well as preliminary ejection target area data that specifies an area of a particular color, which is included in an image to be printed, as a preliminary ejection target area that is used for preliminary ejection; and
a data processor that adds preliminarily-ejected ejection data of another color ink to image data so that on-paper preliminary ejection of said another color is performed as necessary in the area which has the particular color.

14. The printing device according to claim 13 wherein
said data processor checks whether or not an amount of ink discharged on a pixel in an area of the low-lightness color will become excessive if the high-lightness color ink is preliminarily ejected at a position of the pixel and, if so, suppresses the addition of the preliminarily-ejected ejection data, corresponding to the nozzle, to the position of the pixel.

15. A printer driver that generates image data for use in a printing device that has recording heads from which ink is ejected on a printing medium through nozzles, said print driver causing a computer to:
detect pixels that will become a preliminary ejection target area on the printing medium for at least a recording head of particular ink;
set the pixels that was detected, as the preliminary ejection target area; and
add preliminarily-ejected ejection data to image data so that preliminary ejection is performed for nozzles of the recording head of the particular ink in the preliminary ejection target area that was set, said nozzles requiring the preliminary ejection.

16. A printer driver that generates image data for use in a printing device that has a plurality of recording heads from which ink of a plurality of colors is ejected on a printing medium through nozzles, said printer driver causing a computer to:
analyze image data to be printed for detecting a low-lightness area, where ink of a particular low-lightness color included in an image to be printed is recorded, as a preliminary ejection target area;
add preliminarily-ejected ejection data of high-lightness color ink to the image data so that on-paper preliminary ejection of higher-lightness color ink is performed in the low-lightness area as necessary; and
convert the image data, which includes added color elements, to a printer command.
